(19) United States
(12) Patent Application Publication
(10) Pub. No.: US 2013/0177867 A1
(43) Pub. Date: Jul. 11, 2013

(54) ORAL DEVICES HAVING NATURAL GUM BASED MATERIALS THEREIN

(71) Applicants: Anthony Morales, Hollister, CA (US); Hamidreza Abbassmovahedi, Hollister, CA (US); Maria Elena Figueroa, Hollister, CA (US); John Morales, Hollister, CA (US)

(72) Inventors: Anthony Morales, Hollister, CA (US); Hamidreza Abbassmovahedi, Hollister, CA (US); Maria Elena Figueroa, Hollister, CA (US); John Morales, Hollister, CA (US)

(21) Appl. No.: 13/737,891

(22) Filed: Jan. 9, 2013

Related U.S. Application Data
(60) Provisional application No. 61/631,619, filed on Jan. 9, 2012.

(51) Int. Cl. A61J 17/00; A61C 19/06; A61C 5/14

(52) U.S. Cl. CPC A61J 17/00; A61C 5/14; A61C 19/063
USPC 433/48; 606/234; 128/861; 264/16

(57) ABSTRACT

This disclosure relates to oral devices, and more particularly, to oral devices having natural gum materials therein. The oral devices are operable to dispense substances in an oral cavity while carrying out conventional functionalities. The oral device may include a mold having a shape of a conventional oral device. The mold has at least one component, comprising a natural gum based material, which operates within an oral cavity.

### CROSS REFERENCE TO RELATED APPLICATION

### Priority Claim

The present non-provisional patent application claims benefit under 35 U.S.C. §119(e) to U.S. provisional application entitled “Devices having natural gum materials therein” (Application Ser. No. 61/631,619) filed Jan. 9, 2012 herein incorporated by reference for all purposes.

### FIELD

This disclosure relates to oral devices, and more particularly, to oral devices having natural gum based materials therein. The oral devices are operable to dispense substances in an oral cavity while carrying out conventional functionalities.

### BACKGROUND

Conventional oral devices such as pacifiers, protective mouth guards, and dental trays are designed to operate in an oral cavity (e.g. inside of a human or animal's mouth). For example, pacifiers are used to soothe babies and small children, protective mouth guards are used to protect one's teeth while participating in sporting activities, and dental trays are used by dental specialists to administer treatment to a patient's teeth.

Conventional oral devices are typically made of plastic, silicone, rubber, or other non-ingestible materials. Although these devices provide many benefits, they lack the ability to dispense medicaments, vitamins, or other substances during operation. For example, protective mouth guards are used to protect one's teeth during a sporting activity but are unable to dispense substances during operation which requires users to take additional action to obtain medicaments, vitamins, health related supplements, etc.

As such, what is needed is a method of dispensing medicaments, vitamins, herbs, health related supplements or the like during the operation of an oral device.

### SUMMARY

This disclosure relates to oral devices, and more particularly, to oral devices having natural gum materials therein. The oral devices are operable to dispense substances in an oral cavity while carrying out conventional functionalities. In some embodiments, the oral device may include a mold having a shape of a conventional oral device. The mold has at least one component, comprising a natural gum based material, which operates within an oral cavity.

In some embodiments, the natural gum material includes active or inactive ingredients. The active or the inactive ingredients are released into an oral cavity during operation of the device.

The present disclosure further includes a method of forming an oral device having natural gum based materials therein. In some embodiments, the method includes mixing a plurality of substances and water with a natural gum material to form a blend. Next, applying heat to the blend until a foaming boil is formed amongst the blend. In addition, pouring the blend into a molding that has a shape of a conventional oral device. Finally, cooling the blend until the blend transitions from a liquid to a solid state.

### BRIEF DESCRIPTION OF THE FIGURES

To facilitate understanding, identical reference numerals have been used, where possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 illustrates a perspective view of exemplary conventional oral devices.

FIG. 2 illustrates a perspective view of a device resembling a pacifier with a nipple having a natural gum based material.

FIG. 3 illustrates a perspective view of a device resembling a pacifier having a natural gum based body and a detachable mouth guard.

FIG. 4 illustrates a perspective view of a device resembling a pacifier having a natural gum based body.

FIG. 5 is an exploded view of the device illustrated in FIG. 2 according to some embodiments of the present disclosure.

FIG. 6 is an exploded view of the device illustrated in FIG. 2 according to some embodiments of the present disclosure.

FIG. 7 is an exploded view of the device illustrated in FIG. 3.

FIG. 8A illustrates a perspective view of a device resembling a dental tray having a natural gum based body.

FIG. 8B illustrates a cross-sectional view of the device illustrated in FIG. 8A.

FIG. 9 illustrates a perspective view of a device resembling a protective mouth guard having a natural gum based body.

FIG. 10 illustrates a method of forming an oral device having a natural gum based material therein.

FIG. 11 illustrates a perspective view of an oral device resembling a protective mouth guard having a natural gum strip thereon.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

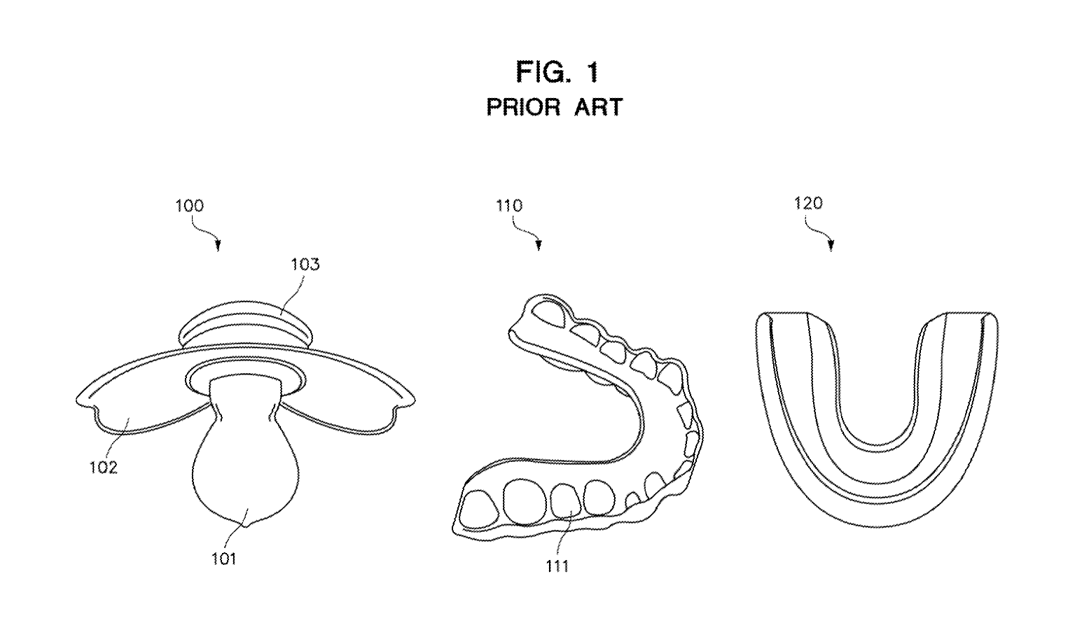

FIG. 1 illustrates a perspective view of exemplary conventional oral devices 100, 110, and 120 which operate in an oral cavity. As shown, FIG. 1 illustrates a conventional pacifier 100, dental tray 110, and protective mouth guard 120. Typically, a pacifier 100 serves as a soothing mechanism to calm a crying child when placed in the child's mouth (i.e. oral cavity). A dental tray 110 is used by dental specialists to administer treatment to a patient's teeth (e.g. via teeth grooves 111). Further, a protective mouth guard 120 is used to protect an athlete's teeth while participating in sporting activities (e.g. football, hockey, boxing, etc.). It should be understood that the aforementioned oral devices are representative, and not exhaustive, and other oral devices may exist.

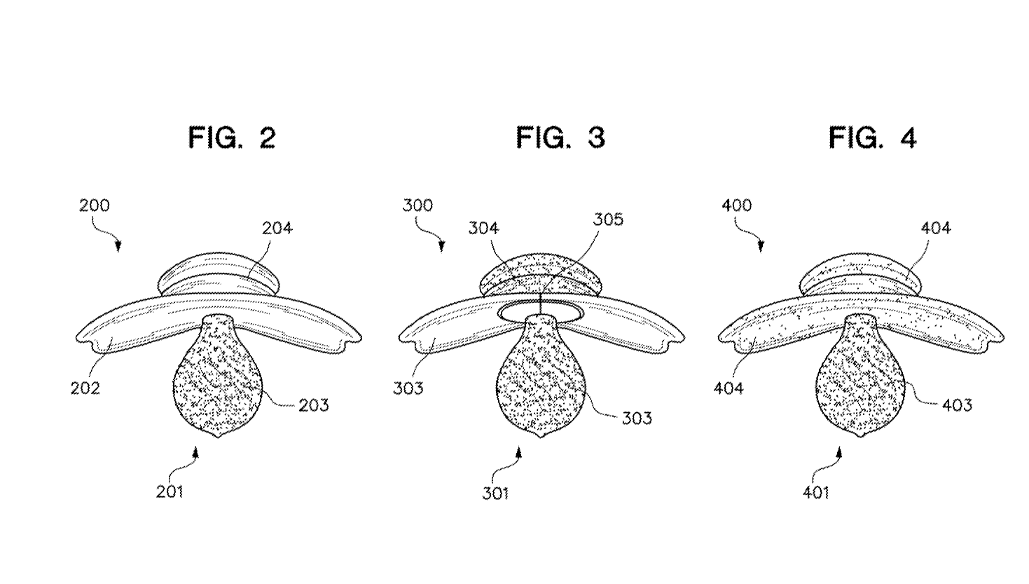

FIG. 2 illustrates a perspective view of a device 200 resembling a pacifier having a nipple 201 with a natural gum based material 203 therein. In some embodiments, device 200 can operate as a conventional pacifier to soothe children and toddlers.

Additionally, because device 200 includes a nipple 201 having a natural gum based material 203, the device 200 may also operate to dispense substances into an oral cavity during normal operation. For example, once a child applies a sucking action to (e.g. sucks) the nipple 201, the natural gum material based 203 therein will dissolve or waste away. Advantageously, substances such as medicaments, herbs, vitamins, health related supplements, and the like can be incorporated into the natural gum based material 203 and ingested by a child while sucking on the nipple 201. Accordingly, devices consistent with the present disclosure, such as device 200, can serve dual roles to provide both conventional and dispensing functionalities.

Device 200 may further include a guard 202 adjacent to nipple 201 which protects a child from choking while using the device 200. Device 200 further includes an optional base component 204 which can entertain a child. For example, base component 204 may include a bell or may be adorned with aesthetic attributes which appeal to children such as a glow in the dark coating. Notably, the guard 202 and base component 204 may be made of plastic, silicone, rubber, or any durable non-toxic material.

It should be understood by one having ordinary skill in the art that a natural gum based material, as used herein, may include any material which comprise a natural gum material. In some embodiments, a natural gum based material may be any material in which the material properties of the natural gum material are evident.

In some embodiments, the consistency of a natural gum material within a natural gum based material may be at a minimum 10% in consistency. However, the amount of natural gum in natural gum based materials material may comprise up to 45% in consistency according to some embodiments of the present disclosure.

In some embodiments, natural gum based material 203 includes a gum arable material. Gum arable may also be referred to as acacia gum, chaargund, char goond, and meska. Gum arable has many benefits because it is non-toxic, grows naturally, and is relatively inexpensive to process. Most notably, gum arabic can be molded into and operate similarly to conventional oral devices.

The present disclosure, however, is not limited to natural gum based materials comprising gum arabic. As such, any material which is non-toxic, moldable, amenable to blend, mix, or bind with other substances, and operable to function as a conventional oral device is within the spirit and scope of the present disclosure. For example, tragacanth, saqhez, frankincense, exudate of an acacia seyal tree, exudate of an acacia senegal tree, or exudate of a copal tree are other examples of natural gum based materials, particularly resins, which may be included in nipple 201.

In some embodiments, natural gum material 203 may contain active or inactive ingredients. For example, natural gum material 203 includes active ingredients to improve one's health. Exemplary active ingredients may include vitamins (e.g. vitamin B6 or C), medicaments, nutrients, and electrolytes which may be added to natural gum based material 203 to improve or maintain one's health. In some embodiments, active ingredients make up approximately 1% of the consistency of the natural gum based material 203 whereas inactive materials make up approximately 99% of the consistency of the natural gum material 203.

Exemplary inactive ingredients may include sugar substitutes, natural flavors, citric acids, natural colors, sweeteners, glazing agents, and gelling agents. In some embodiments, to improve the taste of the natural gum based material 203, sugar substitutes, sweeteners, and natural flavors (e.g. black currant) may be added since some natural gum based materials 203 have a characteristic raw taste in their natural form.

Furthermore, a stabilizing agent may be used to stabilize natural gum based material 203. A stabilizing agent may act as a thickening or gelling agent to increase the viscosity of the material comprising the natural gum based material 203. In their natural state, some natural gum based material 203 may have a pH in the range from 6-8. A citric acid may be used to lower the pH of natural gum based material 203 to a range from 3.5 to 5.5.

Additionally, glazing agents may be added to the natural gum based material 203 to form a thin sheen on the surface of the natural gum based material 203. For example, glazing agents may be added to the natural gum based material 203 to increase the aesthetic appeal of the nipple 201. In some embodiments, vegetable oil or beeswax may be used as glazing agents.

A gelatin substance may also added to help set the resilience of the natural gum based material 203. In some embodiments, the amount of gelatin added to a natural gum when forming a natural gum based material 203 may range from 20 to 120 mL, depending upon the number of components (with the material 203 therein) to be made.

Active and inactive ingredients may be added to a natural gum material 203 by applying a “wet blend” or “dry blend” process. For example, a wet blend process may include using water as a carrier to introduce substances into the natural gum material. In some embodiments, the natural gum material may be in powder form. The natural gum material can be blended or mixed with the substances such that the added substances are distributed throughout the blend.

Once the natural gum material and the desired substances (e.g. active and inactive ingredients) are added to water and mixed, heat can be applied to raise the temperature of the liquid based mixture to a certain threshold enabling compatibility between the natural gum material 203 and the added substances. However, the amount of temperature applied to the blend should be controlled to ensure the material properties of the natural gum based material 203 are maintained. In some embodiments, the temperature should not exceed 200° C.

A dry blending process may be used to mix substances with a natural gum material. In some embodiments when the natural gum material is in powder form, the material may be mixed with other powder based substances to form a mixed powder composite. A mason jar or roller jar may be used to mix the natural gum powder material and the powder based substances. If the natural gum material is in a bulk resin form, the bulk resin material can be grounded to powder form prior to mixing with the powder based substances.

Afterwards, heat can be applied to the mixed powder composite to make the natural gum material 203 more malleable. In some embodiments, the applied heat creates pores in the natural gum material such that the added substances are eventually bound therein. One having ordinary skill in the art may refer to any parts of the aforementioned process as “super blending.” It should be appreciated by those having ordinary skill in the art that the present disclosure is not limited to “wet blending” or “dry blending,” as described. Any process or methodology which blends natural gum materials and other substances together is within the spirit and scope of the present disclosure.

In some embodiments as shown in FIG. 2, a nipple 201 having a natural gum Based material therein can processed such that it can be ingested within a predetermined time frame. It should be appreciated by those having ordinary skill in the art that saliva from a child's mouth will eventually dissolve away the natural gum based material 203. Particularly, enzymes within saliva breaks down the natural gum based material 203 such that a child ingests the natural gum based material 203 along with any active and inactive ingredients therein.

The natural material 203, such as nipple 201, may typically dispense while the child sucks on the nipple 201. The natural gum based material 203 may last anywhere from 45 minutes to 2 hours depending on the consistency of the sucking action applied to the nipple 201 (with occasional intermittent pauses). The dissolve rate of the natural gum material can be set by adding certain materials within the natural gum based material 203 as described below.

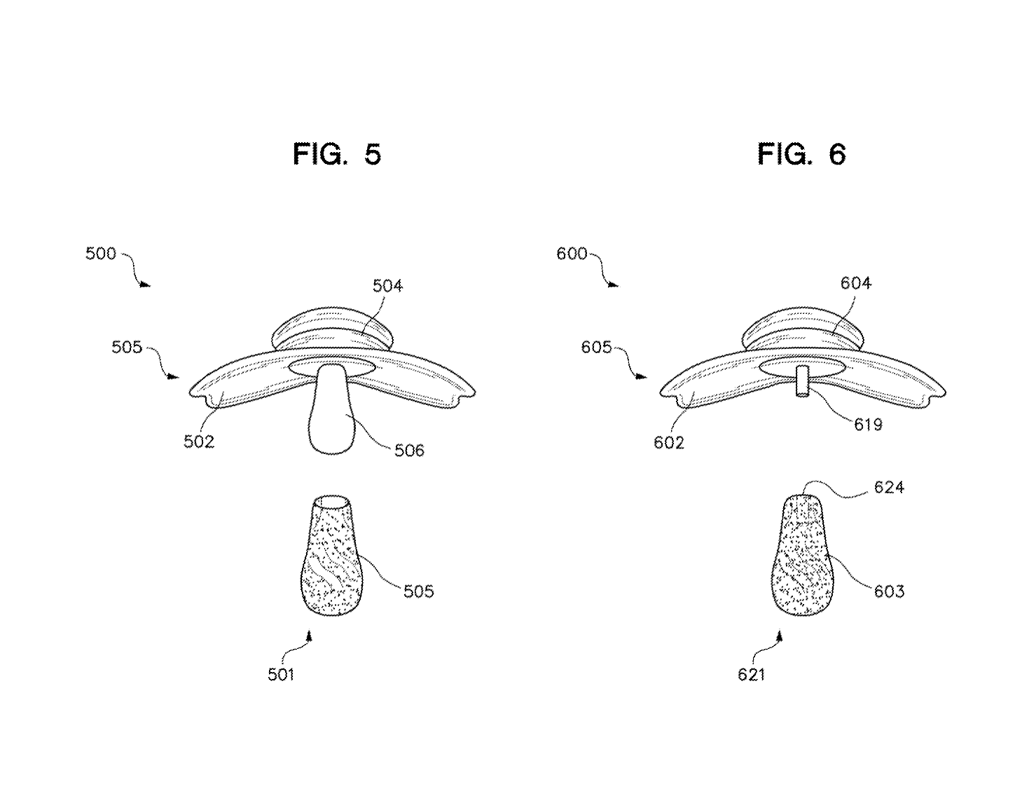

FIG. 5 is an exploded view of the device 200 illustrated in FIG. 2 according to some embodiments of the present disclosure. As shown, device 500 includes a base component 504 adjacent to a guard 502. Most notably, extending from the base component 504 is a nipple 508. Disposed below the pacifier resembling component 505 is a film 501 having a natural gum based material 503 which is formed on the exterior of the nipple 506 as shown in FIG. 2.

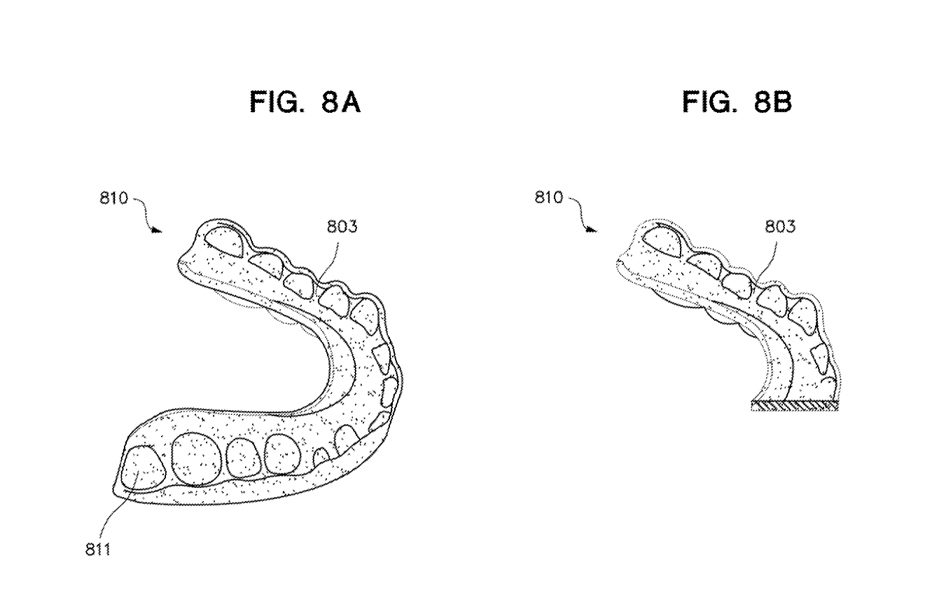

FIG. 8 is an exploded view of the device 200 illustrated in FIG. 2 according to some embodiments of the present disclosure. As shown, device 600 includes a pacifier resembling component 605 with conventional pacifier components—guard 602 and base component 604. However, pacifier resembling component 605 includes a post 619 by which a detachable nipple 621 is coupled thereto.

As shown, detachable nipple 621 comprises a cavity 624 by which the detachable nipple 621 can be coupled to the post 619 of the base component 604. In some embodiments, non-toxic adhesives or gelling agents may be used to ensure that detachable natural gum based nipple 621 adheres to the post 619 of the pacifier resembling component 605.

In operation, when a child applies a sucking action to the detachable natural gum based nipple 621, the child ingests the natural gum material 603. Because the natural gum material 603 will eventually waste away, another detachable natural gum based nipple 621 component can be attached to the pacifier resembling component 605. Advantageously, parents, guardians, and other caretakers can administer various nipples 621 with pre-injected dosages of medicament therein. Accordingly, various detachable natural gum based nipples 621 can be administered according to the diverse needs of children.

FIG. 3 illustrates a perspective view of a device 300 resembling a pacifier having a natural gum based body and a detachable mouth guard 302. As shown, a detachable guard 302 is coupled to a neck portion of the natural gum based body. Most notably, nipple 301 and base component 304 include a natural gum based material 303 whereas guard 302 comprises a material other than natural gum material such as plastics, silicone, rubber, or other non-ingestible materials.

In some embodiments, guard 302 comprises a rigid material to prevent a child from choking when using the device 300. As such, when in use, a child can suck on the nipple 301 or base component 304 of the pacifier 300 which will dissolve and waste away, as previously described. However, since the mouth guard 302 is made from conventional materials, a child can suck thereon and the guard 302 will retain its shape.

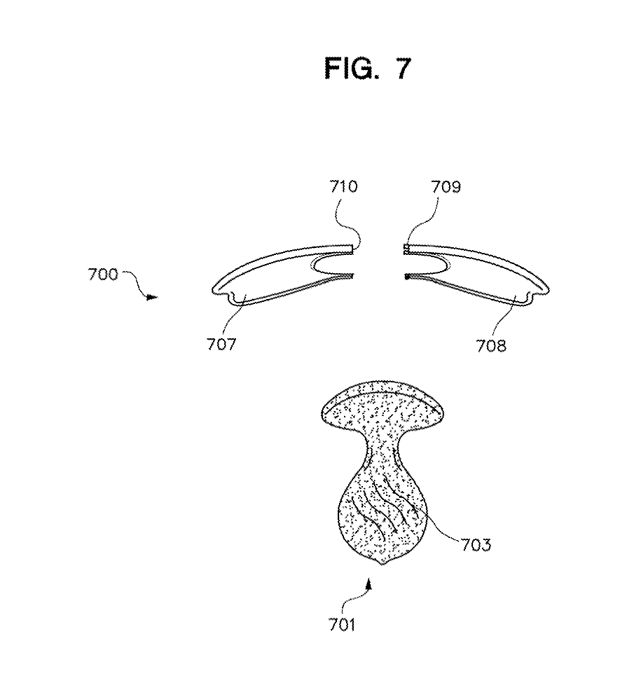

FIG. 7 illustrates an exploded view of the device 300 shown in FIG. 3. As shown, guard 702 includes components 707, 708 which can be coupled together via a snap connection. In particular, guard components 707, 708 feature components 709, 710 which supports a snap connection. It should be understood by one having ordinary skill in the art that the present disclosure is not limited to the guard 702 displayed in FIG. 3 and FIG. 7. The present disclosure is amenable, however, to include any mechanism to couple a guard to the natural gum based body so long as the guard can prevent a child from choking when sucking on the device.

Moving along through the figures, FIG. 4 illustrates a perspective view of a device 400 resembling a pacifier having a natural gum based body. As shown, each component of device 400 comprises a natural gum based material 403. In particular, nipple 401, guard 402, and base component 404 include a natural gum based material 403 therein.

In some embodiments, nipple 401 and base component 404 are processed differently than guard 402. In particular, guard 402 can be processed such that it dissolves at a much slower rate than the nipple 401 and base component 404. It is advantageous that a guard 402 has a significantly slower dissolve rate to ensure that the guard 402 maintains its role as a safety mechanism to prevent children from injury while using the device 400.

In some embodiments, vegetable oil may be used to set the dissolve rate and pliability of each component of the device 400. For example, more vegetable oil may be blended into the natural gum based material 403 of nipple 401 and the base component 404 than in the natural gum material 403 of the mouth guard 402 component.

As such, the durability of the guard 402 can be maintained by intentionally incorporating less vegetable oil therein. Alternatively, the nipple 401 can be processed to last a shorter amount of time relative to the other components upon a sucking action by a child by heavily doping the nipple 401 with more vegetable oil.

It should be appreciated by those having ordinary skill in the art that the present disclosure is not limited to using vegetable oil to set the dissolve rate of different portions of the oral device. As such, any ingredient, substance, or material may be used to set the dissolve rate of components of the pacifier is within the spirit and scope of the present disclosure.

Continuing on through the figures, FIG. 8A illustrates a perspective view of a device 810 resembling a dental tray having a natural gum based body 803. Device 810 may be used by dental specialists to administer treatment to a patient's teeth.

In particular, device 810 comprises a natural gum based body 803 which may include medicament prescribed by a dental specialist to cure oral ailments. For example, medicament prescribed to cure or fight gum disease may be blended within the gum based body 803 and dispensed upon a sucking action by a patient.

Accordingly, a patient can insert device 810 within his or her mouth, bite down or clinch on teeth grooves 811, and suck on the device 810 to dispense and ingest the natural gum and other substances within natural gum based body 803. Depending upon the patient's ailment or treatment to be applied, the device 810 can be designed to include various active and inactive ingredients and dissolve within a certain time period.

Moving forward, FIG. 8B illustrates a cross-sectional view of the device 810 illustrated in FIG. 8A. The device 810 includes a natural gum based body 803 throughout the tray 810. It should be appreciated by one having ordinary skill in the art that the present disclosure is not limited to a dental tray with an exclusive natural gum based body. As such, the present disclosure is amenable to include only a portion of natural gum based materials within the body 803 of the device 800.

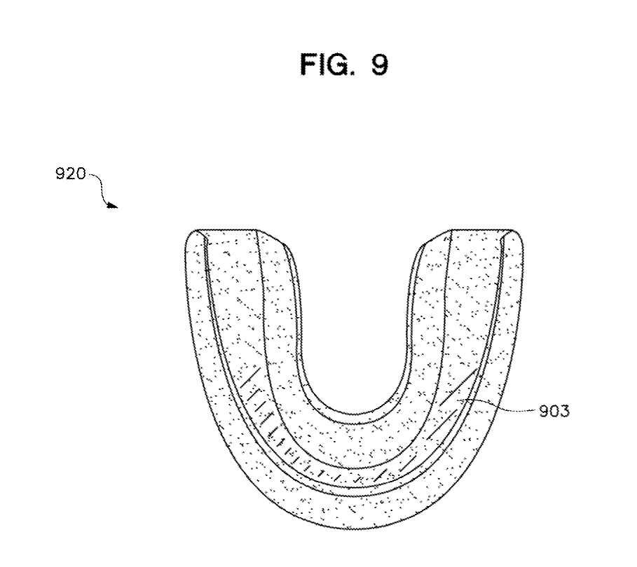

FIG. 9 illustrates a perspective view of a device 920 resembling a protective mouth guard having a natural gum material based body 903. Device 920 may be used to protect an athlete's teeth while participating in sporting activities. For example, device 920 can be used while one participates in high impact sporting activities, such as, basketball, football, soccer, hockey, boxing, kick boxing, MMA, or the like. Most importantly, the device 920 may be used to dispense substances within the natural gum based body 903 while protecting one's teeth.

Moreover, one can use the device 920 during low impact activities such as walking, jogging, dancing, or while being treated in a medical facility.

Device 920 may include health supplements within the natural gum based body 903. For example, vitamins, herbs, amino acids, electrolytes or other substances may be blended within the natural gum based body 903 such that they are ingested as the user clinches and applies a sucking action to the device 920. Because saliva will naturally dissolve the natural gum based body 903, one will eventually ingest the natural gum 903 by virtue of having the device 920 in his or her mouth.

It should be understood by one having ordinary skill in the art that enzymes within saliva will naturally break down and dissolve the natural gum based material. Applying a sucking action may simply increase the rate the natural gum based body 903 dissolves or wastes away.

Moreover, protective mouth guard 920 may be processed such that it lasts a certain amount of time corresponding to a sporting activity. For example, the device 920 may be processed to waste away corresponding to a period of play in a football game. As such, an athlete may consume multiple devices 920 throughout the course of a game.

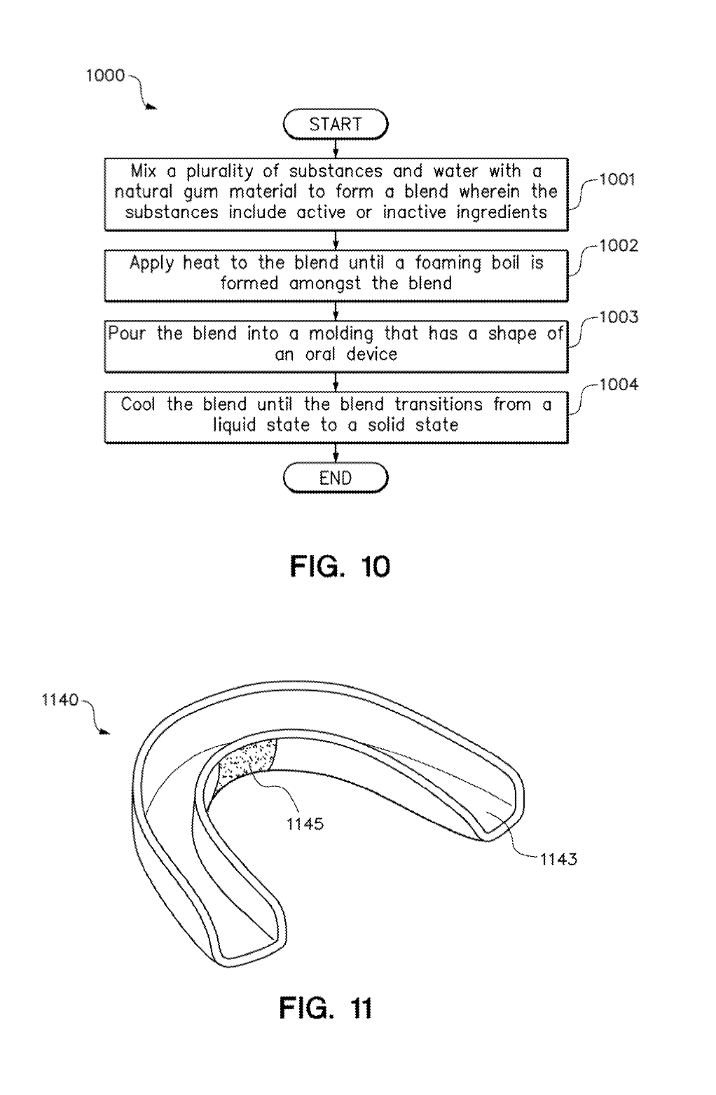

FIG. 10 illustrates a method 1000 of forming an oral device having a natural gum based material therein. Method 1000 can be used to process devices resembling and operating as protective mouth guards, natural gum strips, dental trays, pacifiers and the like.

Starting with block 1001, a plurality of substances and water is mixed with a natural gum material to form a blend. In some embodiments, the substances include active or inactive ingredients. Exemplary natural gums and active/inactive ingredients are listed above.

Next, applying heat to the blend until a foaming boil is formed amongst the blend according to block 1002. In some embodiments, beat is applied until the blend has a temperature of approximately 100° C. However, a temperature in the range from 85° C. to 120° C. may be sufficient to bring the blend to a foaming boil.

Further, pouring the blend into a molding that has a shape of an oral device according to block 1003. In some embodiments, the molding has a shape of a conventional oral device.

Furthermore, cooling the blend until the blend transitions from a liquid state to a solid state according to block 1004. For example, cooling the blend may last for approximately 20 minutes to one hour.

### Experiment A

Method 1000 can be applied to create an oral device that can operate in a conventional capacity and dispense substances during use. Experiment A is consistent, at least in part, to the process described in method 1000.

First, four tablespoons (59.15 mL) of gelatin, eight tablespoons (118.29 mL) of gum arable, one tablespoon (14.79 mL) of grape jell-o, eight tablespoons (118.29 mL) of water, one tablespoon (114.79 mL) of honey and wax (50/50), one tablespoon (14.79 mL) of vegetable oil, 0.5 tablespoons (7.39 mL) of ascorbic acid/potassium/vitamin B6 (50/30/20), and 0.25 tablespoons (3.70 mL) of sugar is mixed until the substances are distributed throughout the blend.

Next, the blend can be placed in a microwave for approximately 100 seconds or until a foaming boil is formed amongst the blend. Alternatively, the blend can be heated on an open stove top (within a container) for five to seven minutes or until a foaming boil is formed amongst the blend.

Next, the blend is poured into a molding shaped as an oral device. For example, the blend may be poured into a molding structure shaped as a protective mouth guard. The blend may be left to cool for approximately 20 minutes at room temperature such that the blend transitions from a liquid state to a solid state. In some embodiments, after the blend cools, the blend has a gummy-like texture. Most notably, the blend may contain a gummy like texture for 3-10 days.

Experiment A can be used to process two complete protective mouth guards (1 inch width, 2 inch length, and 0.5 inch depth) or twenty natural gum strips (similar to those shown in FIG. 11). During testing, the devices wasted away or were ingested completely in 1-2 hours. Notably, the shelf life of the devices lasts about a week.

FIG. 11 illustrates a perspective view of a device 1140 resembling a protective mouth guard having a natural gum strip 1145 thereon. Device 1140 includes a body 1143 which may comprise rubber, silicone, plastic or any other material used in conventional protective mouth guards.

In some embodiments, natural gum strip 1145 has an inherent adhesive quality which may aid the strip 1145 adhere to the device. The adhesiveness of natural gum strip 1145 may be further enhanced by adding other substances to the strip 1145 to help the strip 1145 adhere to the body 1143 of the device 1140. For example, a water [0.5 tablespoons (7.39 mL)]/gum arabic [0.5 tablespoons (7.39 mL)] composite may be applied to a surface where the natural gum strip 1145 will be applied.

Alternatively, a photo curing technique may be utilized to enable the natural gum strip 1145 adhere to the body 1143 of the device 1140. One having ordinary skill in the art should appreciate that photo curing may include hardening a monomeric, oligomeric, or polymeric substrate using ultraviolet light.

In operation, an athlete may insert device 1140 into his or her mouth while participating in sporting activities. Advantageously, the athlete will eventually ingest the natural gum strip 1145. It should be understood that the present disclosure is not limited to the size, shape, and location of the natural gum based strip 1145 shown in FIG. 11. The present disclosure may include, however, a natural gum strip of various sizes, shape, and locations on a substrate so long as an athlete can ingest the natural gum based strip 1145 when the device 1140 is maintained in the athlete's mouth.

Oral devices having natural gum based materials therein have been described. It will be understood that the descriptions of some embodiments of the present disclosure do not limit the various alternative, modified and equivalent embodiments which may be included within the spirit and scope of the present disclosure as defined by the appended claims. Furthermore, some embodiments of the present disclosure may be practiced without these specific details. In other instances, well known methods, procedures, and components have not been described in detail so as not to unnecessarily obscure aspects of the present embodiments.

What is claimed is:

1. A device, comprising:
a mold having a shape of an oral device wherein the mold has at least one component which operates within an oral cavity; and
wherein the at least one component comprises a natural gum material.

2. The device of claim 1, wherein the mold has the shape of at least one of a pacifier, dental tray, or protective mouth guard.

3. The device of claim 1, wherein the at least one component which operates in the oral cavity is a nipple of a pacifier.

4. The device of claim 3, wherein the nipple is detachable from a base of the pacifier.

5. The device of claim 1, wherein the natural gum material comprises at least one of gum arabic, acacia gum, chaargund, char goond, meska, tragacanth, saqhez, frankincense, exudate of an acacia seyal tree, exudate of an acacia senegal tree, or exudate of a copal tree.

6. The device of claim 1, wherein the natural gum material comprises at least one of a plurality of active ingredients or a plurality of inactive ingredients.

7. The device of claim 6, wherein the plurality of inactive ingredients include at least one of sugar substitutes, natural flavors, citric acids, natural colors, sweeteners, glazing agents, or gelling agents.

8. The device of claim 8, wherein the plurality of active ingredients include at least one of a medicament, herb, health related supplement, or vitamin.

9. A device, comprising:
a body having a shape of an oral device wherein the body has a natural gum based material thereon;
wherein the natural gum material based includes at least one of a plurality of active ingredients or a plurality of inactive ingredients; and
wherein the at least one of the plurality of active ingredients or the plurality of inactive ingredients is released into an oral cavity upon a sucking action.

10. The device of claim 9, wherein the body has the shape of a pacifier, dental tray, or protective mouth guard.

11. The device of claim 9, wherein the natural gum based material is within at least one of a film on an exterior of a nipple, a strip on a protective mouth guard, or a strip on a dental tray.

12. The device of claim 10, wherein the plurality of inactive ingredients include at least one of vegetable oil, black currant, sugar, or beeswax.

13. The device of claim 9, wherein the natural gum based material comprises a natural gum material in the range from 10% to 45%.

14. A method, comprising:
mixing a plurality of substances and water with a natural gum material to form a blend wherein at least one of the substances includes at least one of a plurality of active ingredients or a plurality of inactive ingredients;
applying heat to the blend until a foaming boil is formed amongst the blend;
pouring the blend into a molding that has a shape of an oral device; and
cooling the blend.

15. The method of claim 14, wherein the blend is cooled until the blend transitions from a liquid state to a solid state.

16. The method of claim 14, wherein the blend is cooled for approximately 20 minutes.

17. The method of claim 16, wherein the blend is heated to a temperature of 100° C.

18. The method of claim 17, further comprising adding vegetable oil to the blend.

19. The method of claim 17, wherein the plurality of substances include at least one of honey, wax, ascorbic acid, vitamin B6, sugar, vegetable oil, or gelatin.

20. The method of claim 14, wherein the natural gum material includes gum arabic.
